(19) United States
(12) Patent Application Publication
(10) Pub. No.: US 2025/0027916 A1
(43) Pub. Date: Jan. 23, 2025

(54) DATA PROCESSING DEVICE, DATA PROCESSING METHOD, AND DATA PROCESSING SYSTEM

(71) Applicant: SHIMADZU CORPORATION, Kyoto (JP)

(72) Inventor: Harunori KAWAI, Kyoto (JP)

(73) Assignee: SHIMADZU CORPORATION, Kyoto (JP)

(21) Appl. No.: 18/767,151

(22) Filed: Jul. 9, 2024

(30) Foreign Application Priority Data
Jul. 20, 2023 (JP) 2023-117982

(51) Int. Cl. G01N 30/86

(52) U.S. Cl. CPC G01N 30/8631; G01N 30/8682

(57) ABSTRACT

The data processing device includes a data acquisition unit that acquires detection data indicating signal intensity corresponding to a component in a sample detected by the detection device, and a computing unit that processes the detection data acquired by the data acquisition unit. The computing unit is configured to: generate a plurality of analysis data including a peak of the signal intensity based on the detection data; generate a plurality of clusters by grouping the peak included in each of the plurality of analysis data using hierarchical clustering based on peak information corresponding to the peak; and prohibit grouping a plurality of peaks included in the same analysis data, into the same cluster in the hierarchical clustering.

### CROSS REFERENCE TO RELATED APPLICATIONS

This nonprovisional application is based on Japanese Patent Application No. 2023-117982 filed on Jul. 20, 2023 with the Japan Patent Office, the entire contents of which are hereby incorporated by reference.

### BACKGROUND OF THE INVENTION

### Field of the invention

The present disclosure relates to a data processing device, a data processing method, and a data processing system that process data.

### Description of the Background Art

In a case of analyzing components such as compounds in a sample, a plurality of analysis data detected from each of a plurality of samples are compared. For example, there is known a technique called chromatography in which components contained in a sample as an analysis target are separated by a separation device called a chromatograph to obtain a separation result called a chromatogram. The chromatogram obtained by chromatography has a peak of signal intensity. An analyst can specify a component contained in a sample as an analysis target by comparing peaks in each of a plurality of chromatograms among the plurality of chromatograms.

For example, Japanese Patent Laying-Open No. 2023-004872 discloses generating a table in which peaks in each chromatogram are summarized according to peak information such as peak area or peak height for each of the plurality of chromatograms obtained by the chromatography.

### SUMMARY OF THE INVENTION

In the case of generating the table as disclosed in Japanese Patent Laying-Open No. 2023-004872, for example, the analyst observes the plurality of chromatograms, estimates similar peaks among the plurality of chromatograms, and registers the estimated peaks of each chromatogram as peaks of the same component in the table. The analyst can specify the component of each peak in each chromatogram by performing identification processing on the peak of each chromatogram registered in the table as the peak of the same component. However, in order to generate the table as described above, the analyst needs to individually observe the peaks in each of the plurality of chromatograms and compare the peaks with the peaks in other chromatograms, so that it takes enormous work time, and the accuracy of the generated table varies depending on the knowledge or experience of the analyst.

The present disclosure has been made to solve such a problem, and an object of the present disclosure is to provide a technique capable of performing data analysis quickly and with high accuracy while reducing a workload of the analyst.

A data processing device according to an aspect of the present disclosure includes a data acquisition unit that acquires detection data indicating signal intensity corresponding to a component in a sample detected by a detection device, and a computing unit that processes the detection data acquired by the data acquisition unit. The computing unit is configured to: generate a plurality of analysis data including a peak of the signal intensity based on the detection data; generate a plurality of clusters by grouping the peak included in each of the plurality of analysis data using hierarchical clustering based on peak information corresponding to the peak; and prohibit grouping a plurality of peaks satisfying a specific condition based on the peak information, into a same cluster in the hierarchical clustering.

A data processing method according to another aspect of the present disclosure includes acquiring detection data indicating signal intensity corresponding to a component in a sample detected by a detection device; and processing the detection data acquired by the acquiring. The processing the detection data includes generating a plurality of analysis data including a peak of the signal intensity based on the detection data, and generating a plurality of clusters by grouping the peak included in each of the plurality of analysis data using hierarchical clustering based on peak information corresponding to the peak. The generating the plurality of clusters includes prohibiting grouping a plurality of peaks satisfying a specific condition based on the peak information, into a same cluster in the hierarchical clustering.

A data processing program according to still another aspect of the present disclosure causes a computer to execute acquiring detection data indicating signal intensity corresponding to a component in a sample detected by a detection device, and processing the detection data acquired by the acquiring. The processing the detection data includes generating a plurality of analysis data including a peak of the signal intensity based on the detection data, and generating a plurality of clusters by grouping the peak included in each of the plurality of analysis data using hierarchical clustering based on peak information corresponding to the peak. The generating the plurality of clusters includes prohibiting grouping a plurality of peaks satisfying a specific condition based on the peak information, into a same cluster in the hierarchical clustering.

A data processing system according to still another aspect of the present disclosure includes a detection device; and a data processing device that processes data. The data processing device includes a data acquisition unit that acquires detection data indicating signal intensity corresponding to a component in a sample detected by the detection device, and a computing unit that processes the detection data acquired by the data acquisition unit. The computing unit is configured to: generate a plurality of analysis data including a peak of the signal intensity based on the detection data; generate a plurality of clusters by grouping the peak included in each of the plurality of analysis data using hierarchical clustering based on peak information corresponding to the peak; and prohibit grouping a plurality of peaks satisfying a specific condition based on the peak information, into a same cluster in the hierarchical clustering.

The above and other objects, features, aspects and advantages of the present invention will become apparent from the following detailed description of the present invention taken in conjunction with the accompanying drawings.

### BRIEF DESCRIPTION OF THE DRAWINGS

FIG. 1 is a diagram illustrating configurations of a data processing system and a data processing device according to an embodiment.

FIG. 2 is a diagram illustrating three-dimensional vector data constituted by a spectrum vector and a chromatogram generated by the data processing device according to the embodiment.

FIG. 3 is a diagram for describing peak tracking using a plurality of chromatograms.

FIG. 4 is a diagram for describing an example of comparison of peaks between a plurality of chromatograms.

FIG. 5 is a diagram for describing an example of generation of a compound table.

FIG. 6 is a diagram for describing an example of a graph in which peak vectors corresponding to respective peaks included in the plurality of chromatograms are represented in a two-dimensional coordinate system.

FIG. 7 is a diagram for describing an application example of hierarchical clustering according to the centroid method.

FIG. 8 is a diagram for describing an application example of hierarchical clustering according to the centroid method executed by the data processing device according to the embodiment.

FIG. 9 is a flowchart of data processing executed by the data processing device according to the embodiment.

FIG. 10 is a diagram for describing an example of weighting on peak information in hierarchical clustering.

FIG. 11 is a diagram for describing an example of comparison of a matching rate and a reproduction rate in the generation of the compound table.

FIG. 12 is a diagram for describing an example of exclusion of a peak from a cluster in hierarchical clustering.

FIG. 13 is a diagram for describing an example of calculation of a representative value in each cluster grouped by hierarchical clustering.

### DESCRIPTION OF THE PREFERRED EMBODIMENTS

Embodiments will be described in detail with reference to the drawings. Note that, in the drawings, the same or corresponding parts are denoted by the same reference numerals, and the description thereof will not be repeated in principle.

### Configurations of Data Processing System and Data Processing Device

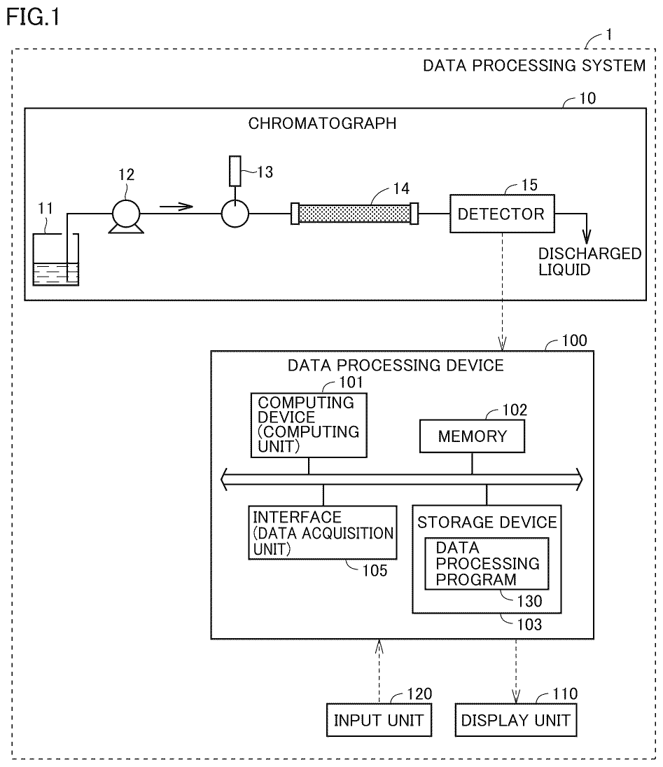

The configurations of a data processing system 1 and a data processing device 100 according to the embodiment will be described with reference to FIG. 1. FIG. 1 is a diagram illustrating the configurations of data processing system 1 and data processing device 100 according to the embodiment. As illustrated in FIG. 1, data processing system 1 includes a chromatograph 10 and data processing device 100.

Chromatograph 10 is an example of a “detection device”. Chromatograph 10 includes a container 11, a liquid feeding pump 12, an injector 13, a column 14, and a detector 15. Container 11 accommodates a mobile phase. Liquid feeding pump 12 sucks the mobile phase from container 11, and feeds the mobile phase at a constant flow rate. Injector 13 injects a sample as the analysis target into the mobile phase fed by liquid feeding pump 12. Column 14 accommodates a stationary phase, and separates various components contained in the sample injected by injector 13. Detector 15 detects components eluted from column 14. As detector 15, for example, an absorbance detector (photo diode array (PDA) detector), a fluorescence detector, a differential refractive index detector, a conductivity detector, a mass spectrometer, or the like is used. Detection data indicating the signal intensity corresponding to the component in the sample detected by detector 15 is output to data processing device 100.

Note that chromatograph 10 according to the embodiment is a liquid chromatograph (LC) using liquid as the mobile phase, but chromatograph 10 may be another chromatograph such as a gas chromatograph using gas as the mobile phase.

In chromatograph 10, a sample as the analysis target is injected into the mobile phase by injector 13. The injected sample reaches column 14 along with the flow of the mobile phase fed by liquid feeding pump 12, and passes through column 14. The various components contained in the sample pass through column 14 for different times depending on the affinity with the stationary phase or the mobile phase. For example, among the components contained in the sample, the component easily adsorbed to the stationary phase has a longer time (also referred to as “retention time”) to pass through column 14 than the component hardly adsorbed to the stationary phase. As a result, various components contained in the sample are separated in a time direction by column 14. The eluate containing the components separated in column 14 is introduced from column 14 to detector 15. Detector 15 outputs the detection data indicating the signal intensity corresponding to a concentration (amount) of the component introduced by column 14. The detection data is processed by data processing device 100 to generate a chromatogram. Note that a solution that has passed through detector 15 is discharged as a waste liquid.

Data processing device 100 may be a general-purpose computer or a computer dedicated to data processing system 1 for processing the detection data from chromatograph 10. Data processing device 100 includes a computing device 101, a memory 102, a storage device 103, and an interface 105.

Computing device 101 is an example of a “computing unit”. Computing device 101 is a computing entity (computer) that executes various kinds of processing by executing various programs. Computing device 101 includes, for example, a processor such as a central processing unit (CPU), a micro processing unit (MPU), or a graphics processing unit (GPU). Note that a processor as an example of computing device 101 has a function of executing various kinds of processing by executing programs, but some or all of the functions may be implemented using a dedicated hardware circuit such as an application specific integrated circuit (ASIC) or a field programmable gate array (FPGA). The “processor” is not limited to a processor in a narrow sense that executes processing in a stored program system such as a CPU or an

MPU, and may include a hardwired circuit such as an ASIC or an FPGA. Therefore, the “processor” as an example of computing device 101 can be read as processing circuitry in which processing is defined in advance by a computer-readable code and/or a hardwired circuit. Note that computing device 101 may be configured with one chip or a plurality of chips. Furthermore, the processor and associated processing circuitry may be configured with a plurality of computers interconnected in a wired or wireless manner via a local area network, a wireless network, or the like. The processor and associated processing circuitry may be configured with a cloud computer to remotely compute on the basis of input data and output a computation result to another device at a remote location.

Memory 102 includes a volatile storage area (for example, working area) that temporarily stores a program code, a work memory, and the like when computing device 101 executes various programs. Examples of a storage unit include volatile memories such as a dynamic random access memory (DRAM) and a static random access memory (SRAM), or nonvolatile memories such as a read only memory (ROM) and a flash memory.

Storage device 103 stores various programs executed by computing device 101, various kinds of data, or the like. Storage device 103 may be one or a plurality of non-transitory computer readable media, or one or a plurality of computer readable storage media. Examples of storage device 103 include a hard disk drive (HDD) and a solid state drive (SSD). Storage device 103 according to the embodiment stores a data processing program 130 for executing data processing of processing detection data acquired by computing device 101 from chromatograph 10.

Interface 105 is an example of a “data acquisition unit”. Interface 105 transmits and receives data to and from an external device or external equipment via wired communication or wireless communication. For example, interface 105 communicates with chromatograph 10 to acquire detection data output from chromatograph 10. In addition, interface 105 may be a communication device that communicates with a cloud server (not illustrated) to transmit detection data acquired from chromatograph 10 to the cloud server or to transmit an execution result of data processing by computing device 101 to the cloud server. Furthermore, interface 105 may transmit and receive data to and from a display unit 110 or an input unit 120, which is a user interface, via wired communication or wireless communication. Data processing device 100 is not limited to one interface 105, and may include a plurality of interfaces 105 according to the number of communication targets.

Display unit 110 is, for example, a display including a liquid crystal panel or the like, and displays an execution result of data processing by data processing device 100. Input unit 120 is, for example, a pointing device such as a keyboard or a mouse, and receives a command from a user. In a case where a touch panel is used as the user interface, display unit 110 and input unit 120 may be integrally formed. Note that display unit 110 and input unit 120 may be included in data processing device 100.

In data processing system 1 configured as described above, data processing device 100 acquires the detection data indicating the signal intensity corresponding to the component in the sample detected by chromatograph 10 in time series via interface 105. The data processing device generates a chromatogram indicating a temporal change in the signal intensity on the basis of the acquired detection data. As a result, data processing device 100 can acquire a chromatogram regarding the component included in the sample as the analysis target.

### Example of Chromatogram

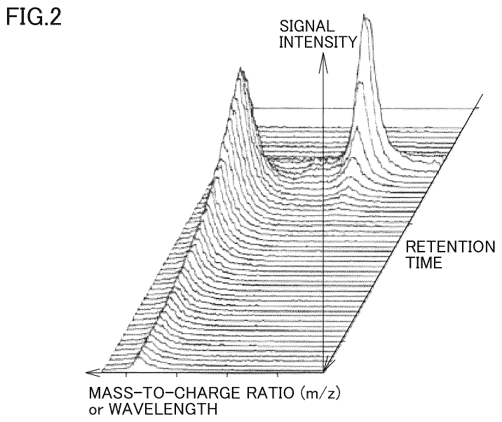

A chromatograph processed by data processing device 100 according to the embodiment will be described with reference to FIG. 2. FIG. 2 is a diagram illustrating three-dimensional vector data constituted by a spectrum vector and a chromatogram generated by data processing device 100 according to the embodiment. Note that, in the embodiment described below, a “compound” is used as an example of the “component”.

Data processing device 100 can generate a spectrum vector on the basis of the detection data acquired from chromatograph 10. For example, in a case where chromatograph 10 is configured to detect ionic strength of various compounds contained in the sample as the signal intensity for each mass-to-charge ratio, data processing device 100 can generate a mass spectrum vector indicating the signal intensity with respect to the mass-to-charge ratio at a specific time timing on the basis of the detection data acquired from chromatograph 10. Alternatively, in a case where chromatograph 10 is configured to detect absorbance of various compounds contained in the sample as the signal intensity for each wavelength, data processing device 100 can generate a wavelength spectrum vector indicating the signal intensity for the wavelength at a specific time timing on the basis of the detection data acquired from chromatograph 10.

As illustrated in FIG. 2, data processing device 100 can generate three-dimensional vector data by arranging the above-described mass spectrum vector or wavelength spectrum vector in time series for each retention time. Data processing device 100 can generate a chromatogram by taking the retention time on a horizontal axis and the signal intensity (ionic strength or absorbance) on a vertical axis. That is, the chromatogram is data indicating a temporal change in signal intensity.

### Example of Peak Tracking

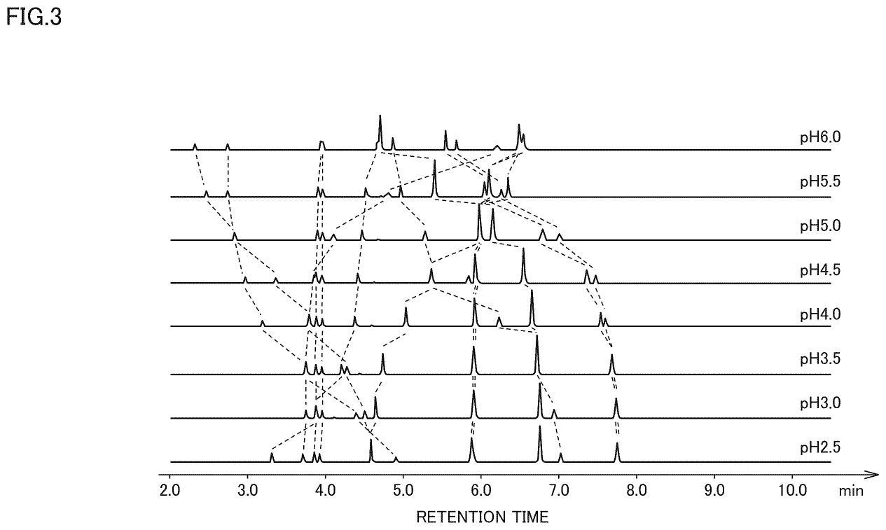

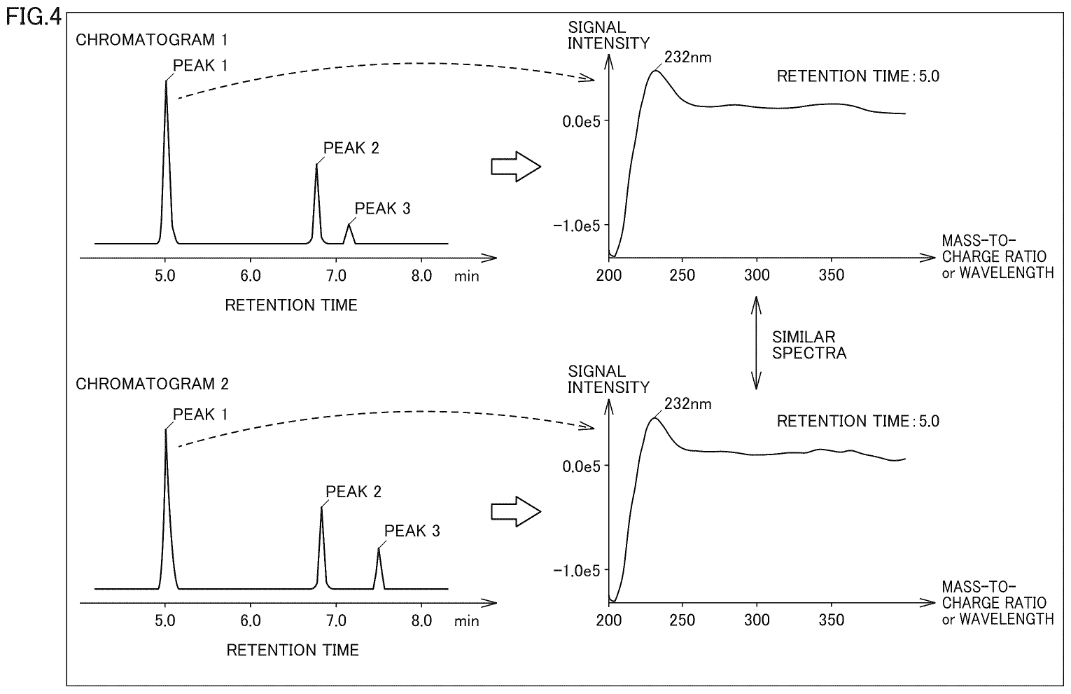

Peak tracking will be described with reference to FIGS. 3 and 4. FIG. 3 is a diagram for describing peak tracking using a plurality of chromatograms. For example, it is assumed that a hydrogen ion concentration index in the solution as the mobile phase is set to a plurality of indices between pH 2.5 and pH 6.0, and a chromatogram at each index is generated.

By comparing a plurality of chromatograms obtained for each separation condition such as the hydrogen ion concentration index, the analyst can examine the optimum separation condition for separating the compounds contained in the sample. At that time, the analyst can examine the optimum separation condition by tracking how the retention time of each peak in each chromatogram is changed according to the separation condition. By performing such peak tracking, the analyst can specify a peak of the same compound in each chromatogram.

Here, when peak tracking is performed, it is required to extract two chromatograms having similar peak information of each peak from a plurality of chromatograms, and to perform peak tracking between the two extracted chromatograms. The peak information includes, for example, at least one of a retention time, a peak number, a peak width, a peak area, a peak area ratio, a peak height, and a peak height ratio. The peak number is the order of the peaks detected by chromatograph 10. The peak width is a width between a time point at which the rising of the peak starts and a time point at which the falling of the peak ends. The peak area is an area of a portion surrounded by the peak. The peak area ratio is a ratio of a peak area of a target peak to a total of peak areas of all peaks included in the same chromatogram. The peak height is the maximum value of the signal intensity at the peak. The peak height ratio is a ratio of a peak height of a target peak to a total of peak heights of all peaks included in the same chromatogram.

For example, the analyst selects two chromatograms, and associates peaks having similar peak information between the two selected chromatograms by peak tracking. For example, in the example of FIG. 3, the degree of similarity is the highest between the chromatogram at pH 6.0 and the chromatogram at pH 5.5 among the plurality of chromatograms. In this case, the analyst performs peak tracking between the chromatogram at pH 6.0 and the chromatogram at pH 5.5. As described above, the analyst can efficiently examine the optimum separation condition by associating similar peaks between a plurality of chromatograms having different separation conditions.

In addition, when comparing peaks between a plurality of chromatograms, the analyst can also compare the peaks on the basis of the spectrum vector (mass spectrum vector, wavelength spectrum vector) of each peak. For example, FIG. 4 is a diagram for describing an example of comparison of peaks between a plurality of chromatograms.

As illustrated in FIG. 4, in a case of comparing a peak 1 of a chromatogram 1 with peak 1 of a chromatogram 2, the analyst compares the shape of the spectrum vector between peak 1 of chromatogram 1 and peak 1 of chromatogram 2. In a case where the shape of the spectrum vector is similar between peak 1 of chromatogram 1 and peak 1 of chromatogram 2, the analyst can predict that peak 1 of chromatogram 1 and peak 1 of chromatogram 2 are peaks corresponding to the same compound.

### Example of Compound Table

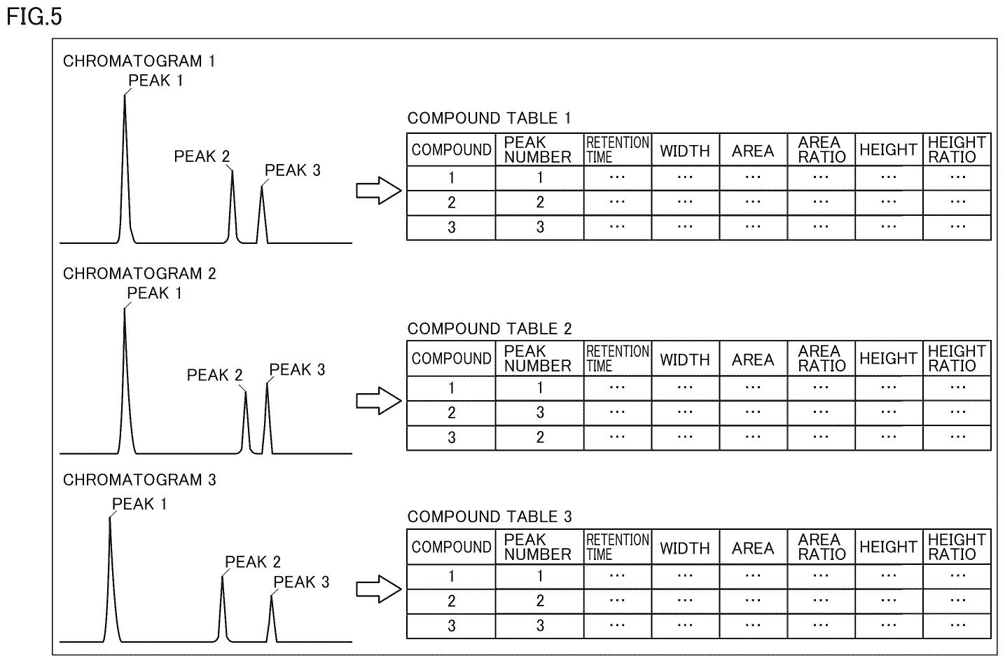

The compound table will be described with reference to FIG. 5. FIG. 5 is a diagram for describing an example of generation of the compound table.

The analyst observes a plurality of chromatograms, estimates similar peaks among the plurality of chromatograms, and registers the estimated peaks of each chromatogram as peaks of the same compound in the compound table.

For example, as illustrated in FIG. 5, the analyst registers peak information of peak 1 as a peak corresponding to a compound 1, registers peak information of a peak 2 as a peak corresponding to a compound 2, and registers peak information of a peak 3 as a peak corresponding to a compound 3 in a compound table 1 of chromatogram 1. The analyst registers peak information of peak 1 as a peak corresponding to compound 1, registers peak information of peak 3 as a peak corresponding to compound 2, and registers peak information of peak 2 as a peak corresponding to compound 3 in a compound table 2 of chromatogram 2. The analyst registers peak information of peak 1 as a peak corresponding to compound 1, registers peak information of peak 2 as a peak corresponding to compound 2, and registers peak information of peak 3 as a peak corresponding to compound 3 in compound table 1 of a chromatogram 3.

That is, as a result of comparing the respective peaks of chromatograms 1 to 3, the analyst predicts that peak 1 of chromatogram 1, peak 1 of chromatogram 2, and peak 1 of chromatogram 3 are similar to each other, and that these peaks are peaks corresponding to compound 1. In addition, as a result of comparing the respective peaks of chromatograms 1 to 3, the analyst predicts that peak 2 of chromatogram 1, peak 3 of chromatogram 2, and peak 2 of chromatogram 3 are similar to each other, and that these peaks are peaks corresponding to compound 2. Furthermore, as a result of comparing the respective peaks of chromatograms 1 to 3, the analyst predicts that peak 3 of chromatogram 1, peak 2 of chromatogram 2, and peak 3 of chromatogram 3 are similar to each other, and that these peaks are peaks corresponding to compound 3.

As described above, the analyst observes a plurality of chromatograms, estimates similar peaks among the plurality of chromatograms, and registers the estimated peaks of each chromatogram as peaks of the same compound in the compound table. However, in order to generate the compound table, the analyst needs to individually observe at least one peak included in each of the plurality of chromatograms and compare the at least one peak with at least one peak included in another chromatogram, so that enormous work time is required. In addition, as illustrated in the example of FIG. 5, even in the case of the same compound, peak numbers may be swapped or there may be many peaks having similar spectrum vectors between a plurality of chromatograms, and the accuracy of the generated compound table varies depending on the knowledge or experience of the analyst.

Therefore, the data processing device according to a first embodiment is configured to perform data analysis of chromatograms quickly and accurately while reducing the workload of the analyst by grouping peaks included in each of a plurality of chromatograms by clustering to generate a plurality of clusters on the basis of peak information corresponding to the peaks.

### Generation of Compound Table by Clustering

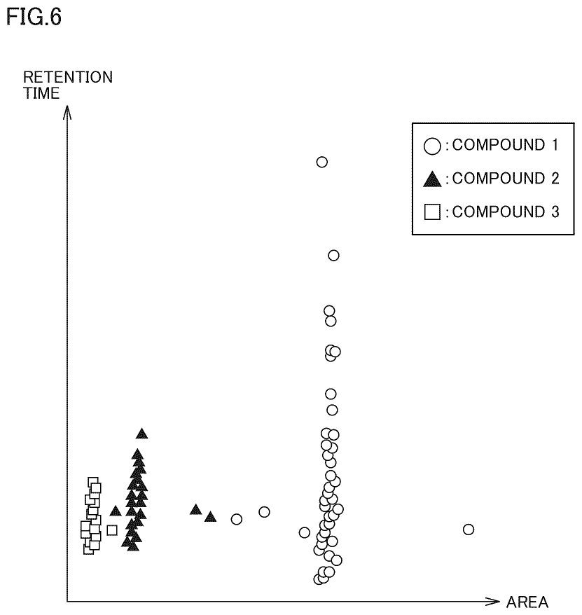

With reference to FIGS. 6 to 12, generation of a compound table by clustering executed by data processing device 100 according to the embodiment will be described. FIG. 6 is a diagram for describing an example of a graph in which peak vectors corresponding to respective peaks included in the plurality of chromatograms are represented in a two-dimensional coordinate system. The “peak vector” is data obtained by converting peak information of each peak into a multidimensional vector in a multidimensional coordinate system in which a plurality of pieces of peak information such as a retention time or a peak area are taken as dimensional axes different from each other. Hereinafter, a point of the peak vector converted into the multidimensional vector in the multidimensional coordinate system is also referred to as “peak point”.

FIG. 6 illustrates a graph obtained by converting peak information of each peak included in a plurality of chromatograms into a two-dimensional vector in a two-dimensional coordinate system in which a horizontal axis represents a peak area and a vertical axis represents a retention time among the peak information. In this graph, the peak point of the peak corresponding to compound 1 is indicated by a circle, the peak point of the peak corresponding to compound 2 is indicated by a triangle, and the peak point of the peak corresponding to compound 3 is indicated by a square.

As illustrated in FIG. 6, the peak point corresponding to each compound tends to gather at a similar place on the graph. This is because a plurality of peaks corresponding to the same compound has peak information similar to each other.

Data processing device 100 can gather the peaks for each kind of compound by grouping the peak points of the peaks included in the plurality of chromatograms having the tendency as illustrated in FIG. 6 by clustering.

Here, examples of the kind of clustering algorithm include non-hierarchical clustering and hierarchical clustering.

The non-hierarchical clustering is a method of grouping the most similar data and classifying the data into a specified number of clusters. The non-hierarchical clustering includes k-means clustering. For example, the k-means clustering is a method in which the number of clusters is determined in advance, each piece of data is randomly allocated to any cluster, the distance between each piece of data and the center of gravity of each cluster is calculated, and each piece of data is allocated again to the cluster having the minimum distance on the basis of the calculated distance. By using the k-means clustering, a plurality of pieces of data having close distances can be gathered into the same cluster, but it is necessary to determine the number of clusters in advance. Therefore, the analyst needs to know in advance the number of compounds (that is, the number of clusters) contained in the sample as a detection target of the chromatogram, and in a case where the analyst does not know in advance the number of compounds (the number of clusters) contained in the sample, the k-means clustering cannot be used.

The hierarchical clustering is a method in which two pieces of data having the minimum distance between data are gathered to generate one cluster, and two clusters having the minimum distance between clusters are gathered to generate one cluster between a plurality of clusters. The hierarchical clustering is classified into a shortest distance method, a longest distance method, a centroid method, and the like depending on how to define the distance between clusters.

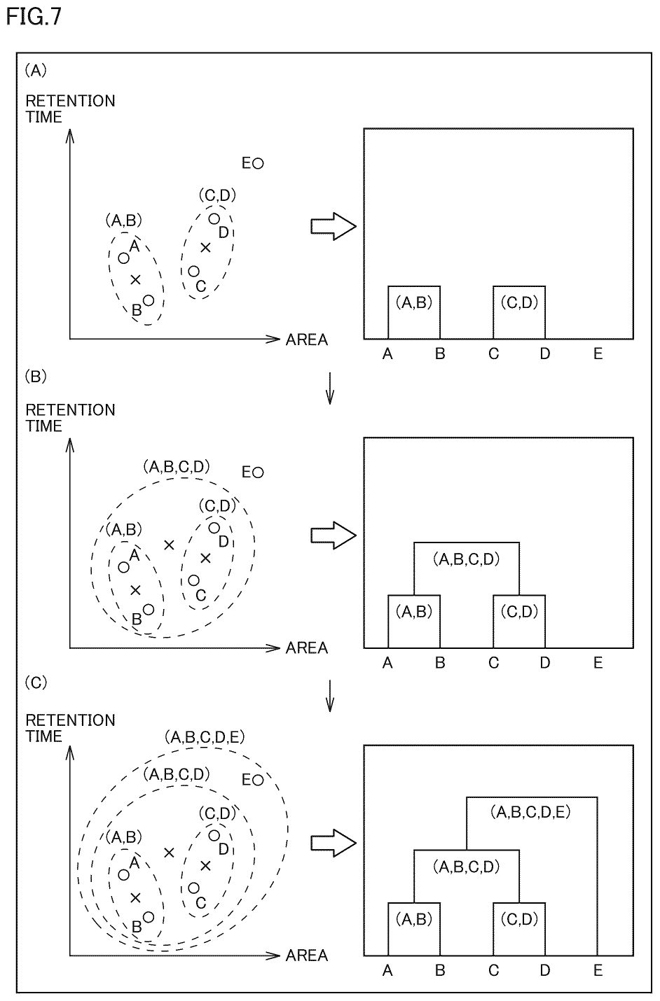

An example of a case where the hierarchical clustering according to the centroid method is applied to grouping of peak points in the chromatogram will be described with reference to FIG. 7. FIG. 7 is a diagram for describing an application example of hierarchical clustering according to the centroid method. In the example illustrated in FIG. 7, peak points A to E respectively corresponding to a plurality of peaks A to E are illustrated in a two-dimensional coordinate system in which a horizontal axis represents a peak area and a vertical axis represents a retention time.

According to the centroid method, as illustrated in FIG. 7(A), among peak points A to E, peak point A and peak point B that have the minimum distance between the two points are gathered to generate one cluster (A, B). Similarly, among peak points A to E, peak point C and peak point D that have the minimum distance are gathered to generate one cluster (C, D). As a result, peak points A to E are divided into cluster (A, B) including peak point A and peak point B, cluster (C, D) including peak point C and peak point D, and peak point E.

Next, as illustrated in FIG. 7(B), among the center of gravity (for example, a center position between peak point A and peak point B) of cluster (A, B), the center of gravity (for example, a center position between peak point C and peak point D) of cluster (C, D), and peak point E, cluster (A, B) and cluster (C, D) that have the minimum distance between two points are gathered to generate one cluster (A, B, C, D). As a result, peak points A to E are divided into cluster (A, B, C, D) including peak point A, peak point B, peak point C, and peak point D, and peak point E.

Next, as illustrated in FIG. 7(C), cluster (A, B, C, D) and peak point E are gathered to generate one cluster (A, B, C, D, E).

As described above, in a case where the hierarchical clustering according to the centroid method is directly applied to the grouping of peaks in the chromatogram, the peaks included in the plurality of chromatograms are finally gathered into one cluster. That is, this result means that each peak included in a plurality of chromatograms is a peak corresponding to the same compound, and is a result that cannot occur in a chromatogram of a sample including a plurality of compounds. This similarly applies to the hierarchical clustering method other than the centroid method.

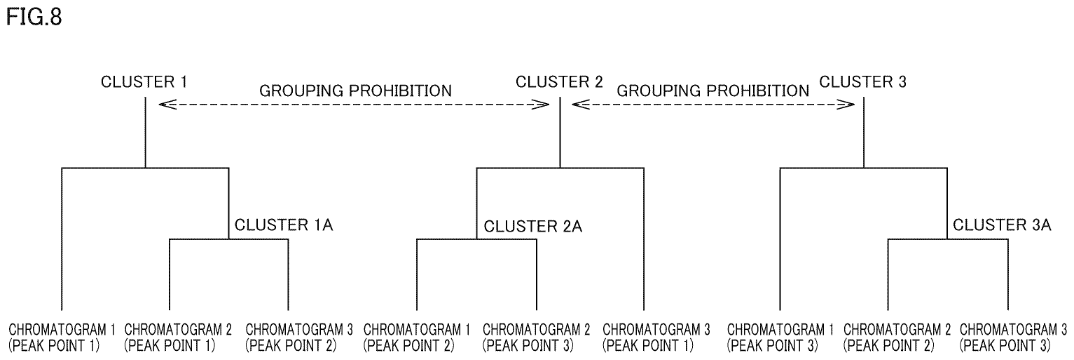

Therefore, as illustrated in FIG. 8, data processing device 100 according to the first embodiment is configured to prohibit that a plurality of peaks satisfying a specific condition based on peak information are grouped into the same cluster when applying the hierarchical clustering to grouping of peaks in the chromatogram. The specific condition includes at least one of that a plurality of peaks as a grouping target are included in the same chromatogram, that spectra of the plurality of peaks as the grouping target are different, and that a difference in peak information between the plurality of peaks as the grouping target exceeds a predetermined range. More specifically, in the hierarchical clustering, data processing device 100 prohibits that a plurality of peaks included in the same chromatogram are grouped into the same cluster. In addition, in the hierarchical clustering, data processing device 100 prohibits that a plurality of peaks having different mass spectra (MS spectra) or different wavelength spectra (PDA spectra) are grouped into the same cluster. In addition, in the hierarchical clustering, data processing device 100 prohibits that a plurality of peaks having a difference in peak information (peak area, peak height, or the like) exceeding a predetermined range are grouped into the same cluster. Note that the predetermined range can be set by the analyst, and in a case where the difference in the peak information is within the predetermined range, there is a higher possibility that a plurality of peaks are peaks corresponding to the same compound than in a case where the difference in the peak information exceeds the predetermined range.

FIG. 8 is a diagram for describing an application example of the hierarchical clustering according to the centroid method executed by data processing device 100 according to the embodiment. FIG. 8 illustrates an example in which peak points 1 to 3 corresponding to three peaks 1 to 3 of each of chromatograms 1 to 3 are grouped by hierarchical clustering by data processing device 100 and thus a plurality of clusters are generated.

As illustrated in FIG. 8, data processing device 100 groups peak point 1 of chromatogram 2 and peak point 2 of chromatogram 3 to generate one cluster 1A. Furthermore, data processing device 100 groups peak point 1 of chromatogram 1 and cluster 1A to generate one cluster 1.

Data processing device 100 groups peak point 2 of chromatogram 1 and peak point 3 of chromatogram 2 to generate one cluster 2A. Furthermore, data processing device 100 groups peak point 1 of chromatogram 3 and cluster 2A to generate one cluster 2.

Data processing device 100 groups peak point 2 of chromatogram 2 and peak point 3 of chromatogram 3 to generate one cluster 3A. Furthermore, data processing device 100 groups peak point 3 of chromatogram 1 and cluster 3A to generate one cluster 3.

In cluster 1, only one peak point is selected and grouped from each of chromatograms 1 to 3, such as peak point 1 of chromatogram 1, peak point 1 of chromatogram 2, and peak point 2 of chromatogram 3. That is, there is a high possibility that peak 1 of chromatogram 1, peak 1 of chromatogram 2, and peak 2 of chromatogram 3 are peaks corresponding to the same compound.

In cluster 2, only one peak point is selected and grouped from each of chromatograms 1 to 3, such as peak point 2 of chromatogram 1, peak point 3 of chromatogram 2, and peak point 1 of chromatogram 3. That is, there is a high possibility that peak 2 of chromatogram 1, peak 3 of chromatogram 2, and peak 1 of chromatogram 3 are peaks corresponding to the same compound.

In cluster 3, only one peak point is selected and grouped from each of chromatograms 1 to 3, such as peak point 3 of chromatogram 1, peak point 2 of chromatogram 2, and peak point 3 of chromatogram 3. That is, there is a high possibility that peak 3 of chromatogram 1, peak 2 of chromatogram 2, and peak 3 of chromatogram 3 are peaks corresponding to the same compound.

Data processing device 100 can generate the compound table as illustrated in FIG. 5 using the plurality of clusters generated in this way. For example, with the compound corresponding to each peak included in cluster 1 as compound 1, data processing device 100 inputs the peak information of peak 1 of chromatogram 1 to a column for compound 1 of compound table 1, inputs the peak information of peak 1 of chromatogram 2 to a column for compound 1 of compound table 2, and inputs the peak information of peak 2 of chromatogram 3 to a column for compound 1 of compound table 3. With the compound corresponding to each peak included in cluster 2 as compound 2, data processing device 100 inputs the peak information of peak 2 of chromatogram 1 to a column for compound 2 of compound table 1, inputs the peak information of peak 3 of chromatogram 2 to a column for compound 2 of compound table 2, and inputs the peak information of peak 1 of chromatogram 3 to a column for compound 2 of compound table 3. With the compound corresponding to each peak included in cluster 3 as compound 3, data processing device 100 inputs the peak information of peak 3 of chromatogram 1 to a column for compound 3 of compound table 1, inputs the peak information of peak 2 of chromatogram 2 to a column for compound 3 of compound table 2, and inputs the peak information of peak 3 of chromatogram 3 to a column for compound 3 of compound table 3. As a result, data processing device 100 can generate the compound table corresponding to each of chromatograms 1 to 3 quickly and accurately while reducing the workload of the analyst.

Note that data processing device 100 may generate one compound table by collecting a plurality of chromatograms without being limited to generating the compound table for each chromatogram as illustrated in FIG. 5. For example, data processing device 100 may calculate a representative value of each of clusters 1 to 3 and generate a table in which the representative values of the plurality of clusters are collected. Specifically, data processing device 100 calculates the representative value of cluster 1 on the basis of the peak information of each of peak 1 of chromatogram 1, peak 1 of chromatogram 2, and peak 2 of chromatogram 3 that are included in cluster 1. Data processing device 100 calculates the representative value of cluster 2 on the basis of the peak information of each of peak 2 of chromatogram 1, peak 3 of chromatogram 2, and peak 1 of chromatogram 3 that are included in cluster 2. Data processing device 100 calculates the representative value of cluster 3 on the basis of the peak information of each of peak 3 of chromatogram 1, peak 2 of chromatogram 2, and peak 3 of chromatogram 3 that are included in cluster 3. Data processing device 100 can generate one compound table by inputting the representative value of cluster 1 in the column for compound 1 of the compound table, inputting the representative value of cluster 2 in the column for compound 2 of the compound table, and inputting the representative value of cluster 3 in the column for compound 3 of the compound table.

Note that the representative value of each cluster may be an average value or a median value of the pieces of the peak information of the peaks included in each cluster. For example, the representative value may be an average value or median value of retention times, an average value or median value of peak widths, an average value or median value of peak areas, an average value or median value of peak area ratios, an average value or median value of peak heights, an average value or median value of peak height ratios, or the like of the peaks included in each cluster.

As described above, data processing device 100 groups peaks 1 to 3 included in each of chromatograms 1 to 3 by hierarchical clustering on the basis of the peak information corresponding to each of peaks 1 to 3 to generate clusters 1 to 3. At this time, data processing device 100 generates clusters 1 to 3 while prohibiting that a plurality of peaks included in the same chromatogram are grouped into the same cluster. In other words, data processing device 100 prohibits that each of clusters 1 to 3 is grouped with another cluster. Data processing device 100 generates the compound table on the basis of the peak information of a peak included in each of the plurality of clusters generated in this way. As a result, data processing device 100 can generate the compound table by performing data analysis of the chromatogram quickly and accurately while reducing the workload of the analyst.

### Flow of Data Processing of Data Processing Device 100

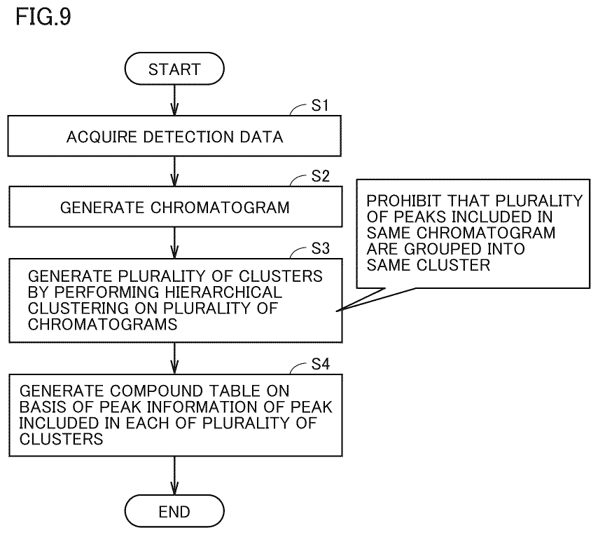

A flow of data processing executed by data processing device 100 will be described with reference to FIG. 9. FIG. 9 is a flowchart of the data processing executed by data processing device 100 according to the embodiment. Processing steps (hereinafter, abbreviated as “S”.) illustrated in FIG. 9 are implemented by computing device 101 executing data processing program 130.

As illustrated in FIG. 9, data processing device 100 acquires detection data indicating the signal intensity corresponding to the components in the sample detected by chromatograph 10 (S1). Data processing device 100 generates a chromatogram indicating a temporal change in the signal intensity on the basis of the detection data acquired from chromatograph 10 (S2).

Data processing device 100 generates a plurality of clusters by performing hierarchical clustering on the plurality of chromatograms generated in the processing of S2 (S3). At this time, data processing device 100 prohibits that a plurality of peaks included in the same chromatogram are grouped into the same cluster.

Data processing device 100 generates the compound table on the basis of the peak information of at least one peak included in each of the plurality of clusters generated in the processing of S3 (S4). Thereafter, data processing device 100 ends the present processing.

As described above, data processing device 100 generates a plurality of chromatograms on the basis of the detection data acquired from chromatograph 10, generates a plurality of clusters by grouping the peaks included in each of the plurality of chromatograms by hierarchical clustering on the basis of the peak information corresponding to the peaks, and generates a compound table using the generated plurality of clusters. Furthermore, in the hierarchical clustering, data processing device 100 prohibits that a plurality of peaks satisfying the specific condition based on the peak information are grouped into the same cluster. Specifically, in the hierarchical clustering, data processing device 100 prohibits that a plurality of peaks included in the same analysis data, a plurality of peaks having different spectra (MS spectra, PDA spectra), or a plurality of peaks having a difference in peak information (peak area, peak height, or the like) exceeding a predetermined range are grouped into the same cluster. As a result, data processing device 100 can generate the compound table by performing data analysis of the chromatogram quickly and accurately while reducing the workload of the analyst.

### Modification Example

The present disclosure is not limited to the above embodiments, and various modifications and applications are possible. Hereinafter, modification examples applicable to the present disclosure will be described.

### (Modification Example 1)

In the example illustrated in FIG. 6, data processing device 100 converts the peak information of each peak included in a plurality of chromatograms into the two-dimensional vector in the two-dimensional coordinate system in which the horizontal axis represents the peak area and the vertical axis represents the retention time among the peak information, but a coordinate system in a three or more dimension may be used without being limited to the two-dimensional coordinate system. In addition, data processing device 100 may generate the multidimensional coordinate system using not only the peak area and the retention time but also other peak information such as the peak number, the peak width, the peak area, the peak area ratio, the peak height, or the peak height ratio.

### (Modification Example 2)

When the analyst manually generates the compound table by himself/herself, the analyst observes not only the peak as an observation target but also a peak appearing before the peak (a peak having a previous peak number) or a peak appearing after the peak (a peak having a subsequent peak number) in the chromatogram, and estimates a compound corresponding to the peak comprehensively.

Therefore, in a case of generating the multidimensional coordinate system, data processing device 100 may generate the multidimensional coordinate system using, in addition to the peak information of a peak (peak as a target of the hierarchical clustering) corresponding to the peak point plotted in the multidimensional coordinate system, peak information of a peak appearing before the peak or peak information of a peak appearing after the peak as coordinate axes. As a result, data processing device 100 can generate a plurality of clusters by hierarchical clustering in consideration of an anteroposterior relationship between a plurality of peaks appearing in the chromatogram.

### (Modification Example 3)

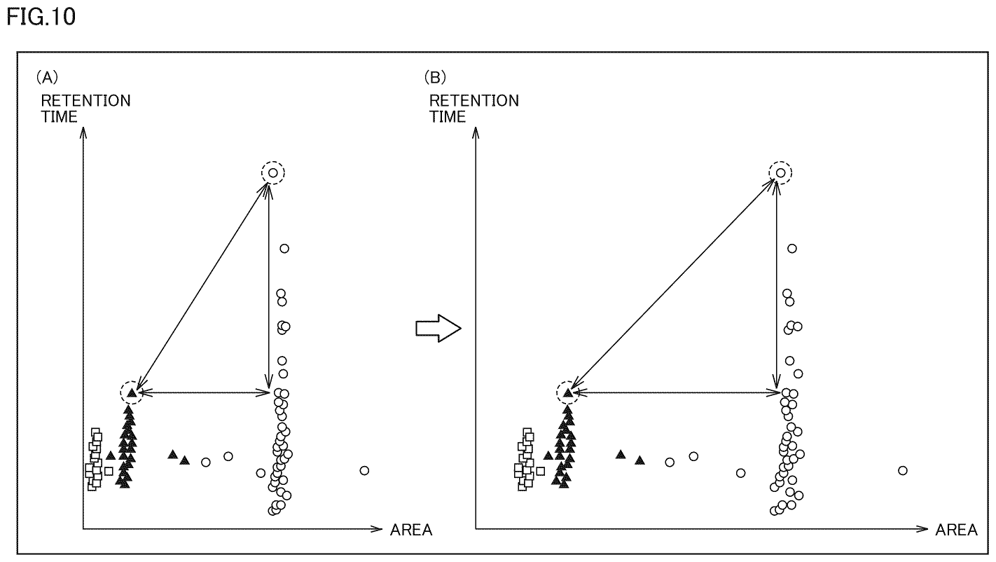

In a case of generating the multidimensional coordinate system, data processing device 100 may perform weighting on at least one piece of peak information. For example, FIG. 10 is a diagram for describing an example of weighting on the peak information in hierarchical clustering.

As illustrated in FIG. 10, data processing device 100 may perform weighting greater than the weighting of the retention time on the area by placing more emphasis on the area than the retention time in the peak information. For example, data processing device 100 may perform weighting greater than the weighting of the retention time on the area by multiplying the scale of the area taken on the horizontal axis by a constant, while not multiplying the scale of the retention time taken on the vertical axis by a constant. As described above, in the two-dimensional coordinate system generated on the basis of the weighted area and the unweighted retention time, the horizontal axis corresponding to the area is more dominant in the calculation of the inter-point distance than the vertical axis corresponding to the retention time. Data processing device 100 can perform hierarchical clustering such that the peak information to be emphasized is more affected, by converting the peak information of each peak included in the plurality of chromatograms into the two-dimensional vector in the weighted two-dimensional coordinate system and performing the hierarchical clustering.

### (Modification Example 4)

In a case of calculating the inter-point distance at the plurality of peak points plotted in the multidimensional coordinate system, data processing device 100 may calculate a difference between real numbers (scalar) of peak information of the peak points such as the retention time, the peak area, and the peak width, and may group the two peak points at which the calculated difference is minimized. For example, data processing device 100 may calculate the difference between the real numbers (scalar) of the peak information at a peak point a and a peak point b by calculating the following Expression (1).

$$\begin{matrix}[ Formula 1 ] & \\ a - b & ( 1 )\end{matrix}$$

Data processing device 100 may group peak point a and peak point b in a case where a calculation result calculated by Expression (1) is minimized.

### (Modification Example 5)

The peak points plotted in the multidimensional coordinate system are points of peak vectors represented in the multidimensional coordinate system. Therefore, in a case of calculating the inter-point distance at the plurality of peak points plotted in the multidimensional coordinate system, data processing device 100 may calculate the difference between the peak vectors corresponding to the respective peak points and group two peak points at which the calculated difference is minimized. For example, data processing device 100 may calculate the difference between the peak vector corresponding to peak point a and the peak vector corresponding to peak point b by calculating the following Expression (2).

$$\begin{matrix}[ Formula 2 ] & \\ 1 - cos θ = 1 - \frac{\vec{a} \cdot \vec{b}}{\vert \vec{a} \vert \cdot \vert \vec{b} \vert} & ( 2 )\end{matrix}$$

In Expression (2), θ is an angle formed by the peak vector corresponding to peak point a and the peak vector corresponding to peak point b. Data processing device 100 may group peak point a and peak point b in a case where a calculation result calculated by Expression (2) is minimized.

### (Modification Example 6)

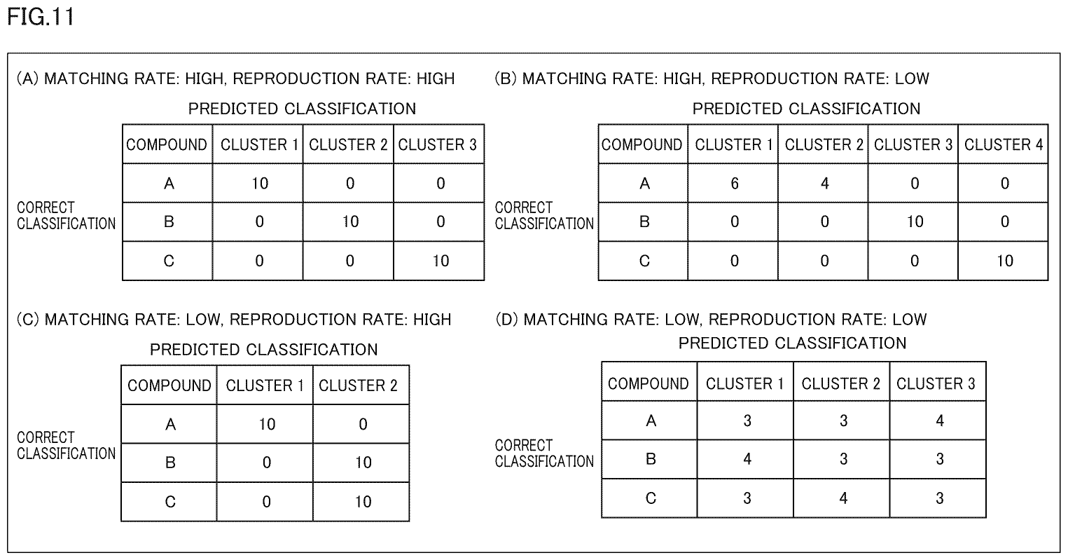

FIG. 11 is a diagram for describing an example of comparison of a matching rate and a reproduction rate in the generation of the compound table. FIG. 11 illustrates a correspondence relationship between a correct answer and a prediction of a case of predicting which peak corresponds to compounds A to C for 30 peaks included in at least one chromatogram. Note that, in the example illustrated in FIG. 11, in the 30 peaks, 10 peaks corresponding to compound A, 10 peaks corresponding to compound B, and 10 peaks corresponding to compound C are included.

In the example illustrated in FIG. 11(A), in the 30 peaks, 10 peaks corresponding to compound A are grouped into cluster 1, 10 peaks corresponding to compound B are grouped into cluster 2, and 10 peaks corresponding to compound C are grouped into cluster 3. As described above, in the example of FIG. 11(A), 10 peaks corresponding to compound A, 10 peaks corresponding to compound B, and 10 peaks corresponding to compound C are equally divided and grouped into clusters 1 to 3. It can be said that such a compound table has a high matching rate and a high reproduction rate.

In the example illustrated in FIG. 11(B), in the 30 peaks, 6 peaks corresponding to compound A are grouped into cluster 1, 4 peaks corresponding to compound A are grouped into cluster 2, 10 peaks corresponding to compound B are grouped into cluster 3, and 10 peaks corresponding to compound C are grouped into cluster 4. As described above, in the example of FIG. 11(B), 10 peaks corresponding to each of compounds B and C are equally divided and grouped into clusters 3 and 4, while 10 peaks corresponding to compound A are divided and grouped into two clusters 1 and 2 instead of one cluster. It can be said that such a compound table has a high matching rate and a low reproduction rate.

In the example illustrated in FIG. 11(C), in the 30 peaks, 10 peaks corresponding to compound A are grouped into cluster 1, and 10 peaks corresponding to compound B and 10 peaks corresponding to compound C are grouped into cluster 2. As described above, in the example of FIG. 11(C), 10 peaks corresponding to compound A are grouped into cluster 1, while 10 peaks corresponding to each of compounds B and C are grouped into one cluster 2 without being divided into two clusters. It can be said that such a compound table has a low matching rate and a high reproduction rate.

In the example illustrated in FIG. 11(D), in the 30 peaks, three peaks corresponding to compound A, four peaks corresponding to compound B, and three peaks corresponding to compound C are grouped into cluster 1, three peaks corresponding to compound A, three peaks corresponding to compound B, and four peaks corresponding to compound C are grouped into cluster 2, and four peaks corresponding to compound A, three peaks corresponding to compound B, and three peaks corresponding to compound C are grouped into cluster 3. As described above, in the example of FIG. 11(D), 10 peaks corresponding to compound A, 10 peaks corresponding to compound B, and 10 peaks corresponding to compound C are grouped to be included in any of clusters 1 to 3. It can be said that such a compound table has a low matching rate and a low reproduction rate.

Here, in a case where the compound table having a high matching rate and a low reproduction rate as illustrated in FIG. 11(B) is compared with the compound table having a low matching rate and a high reproduction rate as illustrated in FIG. 11(C), in the data analysis of the chromatogram, the compound table of FIG. 11(B) is more preferable as a result than the compound table of FIG. 11(C). This is because, in a case where peaks corresponding to a plurality of different kinds of compounds are mixed in one cluster generated by hierarchical clustering as illustrated in FIG. 11(C), the analyst cannot specify one compound on the basis of the one cluster, and inconvenience occurs in practical use. On the other hand, in a case where, although the number of pieces of data is small, only peaks corresponding to one kind of compound are mixed in one cluster generated by hierarchical clustering as illustrated in FIG. 11(B), the analyst can specify one compound on the basis of the one cluster.

Therefore, in the generation of the compound table by data processing device 100, the matching rate is emphasized rather than the reproduction rate. Therefore, in order to improve the matching rate, data processing device 100 is configured to execute some kinds of processing as described below.

As a measure for improving the matching rate, data processing device 100 may prohibit that the compound table is generated using one cluster according to the number of peaks included in the one cluster among the plurality of clusters. For example, in a case where a clustering result as illustrated in FIG. 11(B) is obtained, data processing device 100 may prohibit that the compound table is generated using cluster 2 having the smaller number of pieces of data among cluster 1 and cluster 2 that include the peak corresponding to same compound A. Alternatively, in a case where the number of peaks included in one cluster among a plurality of clusters is less than a predetermined number, data processing device 100 may prohibit that the compound table is generated using the one cluster. For example, in a case where a clustering result as illustrated in FIG. 11(B) is obtained, data processing device 100 may prohibit that the compound table is generated using cluster 2 in which the number of pieces of data is less than five. Note that the predetermined number as a threshold value may be settable by the analyst.

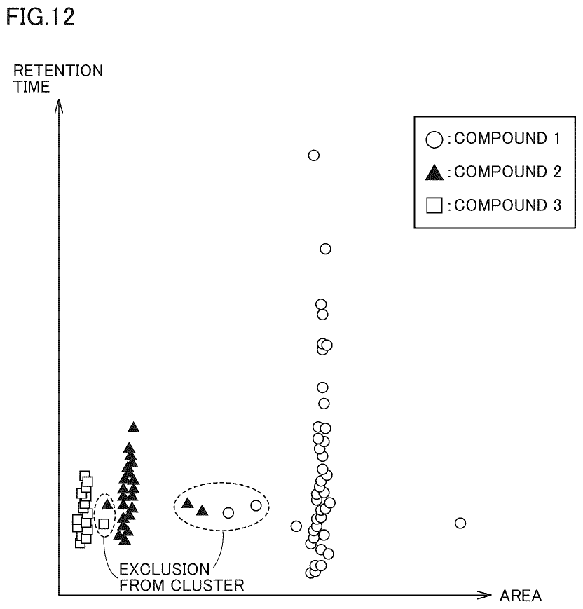

As a measure for improving the matching rate, data processing device 100 may exclude, among peaks included in one cluster, the peak close to a peak included in another cluster from the one cluster. For example, FIG. 12 is a diagram for describing an example of exclusion of a peak from a cluster in hierarchical clustering. As illustrated in FIG. 12, peak points surrounded by the broken line are separated from other peak points corresponding to the same kind of compound by a predetermined distance or more. Such peak points may be caused by a mistake or erroneous detection of waveform processing at the time of generating a chromatogram, and in a case where hierarchical clustering is performed using such peak points, the matching rate may be reduced. Therefore, it is preferable that data processing device 100 performs clustering by excluding the peak points separated from other peak points corresponding to the same kind of compound by a predetermined distance or more, such as peak points surrounded by the broken line. In the example of FIG. 12, data processing device 100 may exclude the peak point indicated by a circle surrounded by the broken line from the cluster corresponding to compound 1, exclude the peak point indicated by a triangle surrounded by the broken line from the cluster corresponding to compound 2, and exclude the peak point indicated by a square surrounded by the broken line from the cluster corresponding to compound 3.

As a measure for improving the matching rate, data processing device 100 may extract a peak for generating the compound table by calculating the following Expression (3).

$$\begin{matrix}[ Formula 3 ] & \\ {p}_{i} = ( {\sum }_{j ∈ Other Cluster} \frac{1}{distance ( {x}_{i} , {x}_{j} )} ) - ( {\sum }_{j ∈ Same Cluster} \frac{1}{distance ( {x}_{i} , {x}_{j} )} ) & ( 3 )\end{matrix}$$

In the above Expression (3), the first term represents the sum of the reciprocal of the distance between the target peak point included in one cluster and another peak point included in another cluster, and the second term represents the sum of the reciprocal of the distance between the target peak point included in one cluster and another peak included in the one cluster. In a case where a value pi calculated by Expression (3) is negative, it can be said that the target peak point is close to other peak points in the grouped own cluster and is separated from other peak points in the other cluster. On the other hand, in a case where value pi calculated by Expression (3) is positive, it can be said that the target peak point is far from other peak points in the grouped own cluster and is close to other peak points in the other cluster. Therefore, data processing device 100 may extract only peak points for which value Pi calculated by Expression (3) is negative, and generate the compound table using only the extracted peak points.

Note that Expression (3) may be rewritten into the following Expression (4).

$$\begin{matrix}[ Formula 4 ] & \\ {p}_{i} = ( {\sum }_{j ∈ Other Cluster} f ( distance ( {x}_{i} , {x}_{j} ) ) ) - ( {\sum }_{j ∈ Same Cluster} f ( distance ( {x}_{i} , {x}_{j} ) ) ) & ( 4 )\end{matrix}$$

In Expression (4), the first term represents the sum of values obtained by converting the distance between the target peak point included in one cluster and another peak point included in another cluster using a function f that monotonically decreases with respect to the distance, and the second term represents the sum of values obtained by converting the distance between the target peak point included in one cluster and another peak included in the one cluster using function f that monotonically decreases with respect to the distance.

In addition, Expressions (3) and (4) may be rewritten into the following Expression (5).

$$\begin{matrix}[ Formula 5 ] & \\ {p}_{i} = - ( {\sum }_{j ∈ Other Cluster} f ( distance ( {x}_{i} , {x}_{j} ) ) ) + ( {\sum }_{j ∈ Same Cluster} f ( distance ( {x}_{i} , {x}_{j} ) ) ) & ( 5 )\end{matrix}$$

In Expression (5), the first term represents the sum of values obtained by converting the distance between the target peak point included in one cluster and another peak point included in another cluster using a function f that monotonically decreases with respect to the distance, and the second term represents the sum of values obtained by converting the distance between the target peak point included in one cluster and another peak included in the one cluster using function f that monotonically decreases with respect to the distance.

### (Modification Example 7)

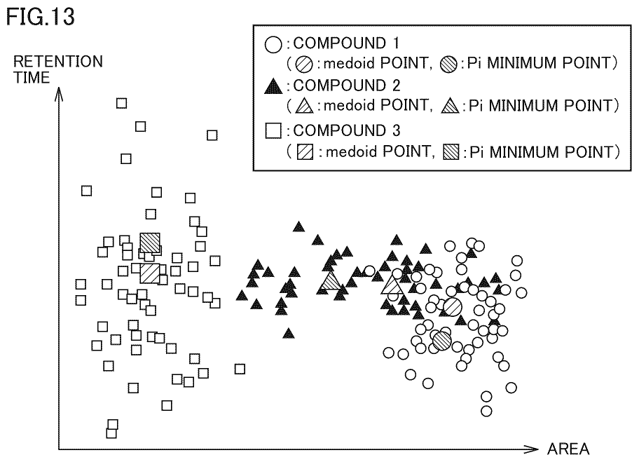

In a case of calculating the representative value of one cluster, data processing device 100 may specify a representative peak from among peaks included in the one cluster, and calculate the representative value of the cluster on the basis of the peak information of the representative peak. FIG. 13 is a diagram for describing an example of calculation of the representative value in each cluster grouped by hierarchical clustering.

For example, as illustrated in FIG. 13, data processing device 100 may extract a medoid point of each cluster on the basis of the peak information of the peak points included in each of clusters corresponding to compounds 1 to 3, as a representative value. Data processing device 100 may calculate the peak information of the extracted medoid point as the representative value. Note that the medoid point is a point at which, among peak points included in one cluster, the sum of distances to other peaks included in the one cluster (for example, in Expression (5), the calculation result of the second term in the case of f(x)=x) is minimized.

Here, in the medoid point, a distance difference from another peak point in the cluster including the medoid point is considered, but a distance difference (for example, the calculation result of the first term in Expression (4) and (5)) from another peak point in another cluster is not considered. Therefore, there may be a case where the medoid point is close to the cluster corresponding to compound 1, such as the medoid point of the cluster corresponding to compound 2 in FIG. 13.

Therefore, it is preferable that data processing device 100 sets the peak point at which value Pi calculated by the above-described Expressions (3) to (5) is minimized, as a representative peak point of each cluster, and calculates the representative value of the cluster on the basis of the peak information of the representative peak point, as the representative value. As described above, in each cluster, data processing device 100 extracts the peak point at which value Pi calculated by Expressions (3) to (5) is minimized, and generates the compound table by gathering the representative values of the extracted representative peak points, thereby generating the compound table with high accuracy.

### (Modification Example 8)

In the above-described embodiment, the chromatogram is used as the analysis data, but data processing device 100 is also applicable to analysis data having a plurality of peaks other than the chromatogram.

Note that the above-described embodiments and modification examples can be appropriately combined and applied to one data processing system 1 and one data processing device 100.

### [Aspects]

It is understood by those skilled in the art that the plurality of exemplary embodiments described above are specific examples of the following aspects.

(Clause 1) A data processing device according to an aspect includes a data acquisition unit that acquires detection data indicating signal intensity corresponding to a component in a sample detected by a detection device, and a computing unit that processes the detection data acquired by the data acquisition unit. The computing unit is configured to: generate a plurality of analysis data including a peak of the signal intensity based on the detection data; generate a plurality of clusters by grouping the peak included in each of the plurality of analysis data using hierarchical clustering based on peak information corresponding to the peak; and prohibit grouping a plurality of peaks satisfying a specific condition based on the peak information, into a same cluster in the hierarchical clustering.

With the data processing device according to Clause 1, since a plurality of clusters are generated by grouping the peak included in each of the plurality of analysis data using hierarchical clustering based on the peak information corresponding to the peak, the analyst does not need to generate the plurality of clusters by estimating the peaks common among the plurality of analysis data by himself/herself, and can quickly perform the data analysis. Furthermore, in the hierarchical clustering, since data processing device prohibits that the plurality of peaks satisfying the specific condition based on the peak information are grouped into the same cluster, the plurality of peaks satisfying the specific condition based on the peak information are not grouped into the same cluster as the same component, and the data analysis can be performed with high accuracy using the hierarchical clustering.

(Clause 2) In the data processing device according to Clause 1, the detection device is a chromatograph. Each of the plurality of analysis data is a chromatogram illustrating a peak of the signal intensity for a retention time.

With the data processing device described in the second section, the analyst does not need to generate the plurality of clusters by estimating the peaks common among the plurality of chromatograms by himself/herself, and can quickly perform the data analysis with high accuracy.

(Clause 3) In the data processing device according to Clause 1 or 2, the computing unit is configured to generate a table based on the peak information corresponding to a peak included in each of the plurality of clusters.

With the data processing device according to Clause 3, the analyst does not need to generate the compound table by estimating the peaks common among the plurality of chromatograms by himself/herself, and can quickly generate the compound table with high accuracy.

(Clause 4) In the data processing device according to Clause 3, the computing unit is configured to: calculate a representative value of each of the plurality of clusters; and generate the table based on the representative value of each of the plurality of clusters.

With the data processing device according to Clause 4, the analyst can generate the compound table based on the representative value of each of the plurality of clusters.

(Clause 5) In the data processing device according to Clause 3 or 4, the computing unit is configured to prohibit generating the table using one cluster according to the number of peaks included in the one cluster among the plurality of clusters.

With the data processing device according to Clause 5, for example, since the analyst can prohibit the generation of the compound table using cluster 2 in which the number of peaks included in one cluster is small, the matching rate in the generation of the compound table can be improved.

(Clause 6) In the data processing device according to any one of Clauses 3 to 5, the computing unit is configured to generate the table using a peak extracted based on a difference between a peak included in one cluster and another peak included in the one cluster and a difference between a peak included in the one cluster and a peak included in another cluster.

With the data processing device according to Clause 6, since the analyst can generate the compound table using a peak extracted based on a difference between a peak included in one cluster and another peak included in the one cluster and a difference between a peak included in the one cluster and a peak included in another cluster, the matching rate in the generation of the compound table can be improved.

(Clause 7) In the data processing device according to Clause 4, the computing unit is configured to calculate the representative value using a peak extracted based on a difference between a peak included in one cluster and another peak included in the one cluster and a difference between a peak included in the one cluster and a peak included in another cluster.

With the data processing device according to Clause 7, the analyst can generate the compound table on the basis of the representative value calculated using a peak extracted based on a difference between a peak included in one cluster and another peak included in the one cluster and a difference between a peak included in the one cluster and a peak included in another cluster.

(Clause 8) In the data processing device according to any one of Clauses 1 to 7, the computing unit is configured to perform weighting, the weighting being larger than weighting of other peak information, on at least one piece of the peak information and execute the hierarchical clustering based on the weighted peak information.

With the data processing device according to Clause 8, the analyst can execute the hierarchical clustering such that the peak information desired to be emphasized is more affected.

(Clause 9) In the data processing device according to any one of Clauses 1 to 8, the computing unit is configured to exclude, among peaks included in one cluster, a peak close to a peak included in another cluster from the one cluster.

With the data processing device according to Clause 9, since the analyst can generate the compound table by excluding, among peaks included in one cluster, a peak close to a peak included in another cluster from the one cluster, the matching rate in the generation of the compound table can be improved.

(Clause 10) In the data processing device according to any one of Clauses 1 to 9, the peak information includes at least one of the retention time, a number, a width, an area, an area ratio, a height, and a height ratio at a peak.

With the data processing device according to Clause 10, the analyst can generate the compound table on the basis of at least one of the retention time, the number, the width, the area, the area ratio, the height, and the height ratio of the peak included in the chromatogram.

(Clause 11) In the data processing device according to any one of Clauses 1 to 10, the peak information includes at least one of the retention time, a number, a width, an area, an area ratio, a height, and a height ratio at a peak before or after a peak as a target of the hierarchical clustering.

With the data processing device according to Clause 11, the analyst can generate the compound table by generating a plurality of clusters by the hierarchical clustering in consideration of an anteroposterior relationship between a plurality of peaks appearing in the chromatogram.

(Clause 12) In the data processing device according to any one of Clauses 1 to 11, the hierarchical clustering is clustering according to at least one of a shortest distance method, a longest distance method, and a centroid method.

With the data processing device according to Clause 12, the analyst can generate the compound table using a plurality of clusters generated by the hierarchical clustering according to at least one of the shortest distance method, the longest distance method, and the centroid method.

(Clause 13) In the data processing device according to any one of Clauses 1 to 12, the specific condition includes at least one of a condition that the plurality of peaks are included in same analysis data, a condition that spectra of the plurality of peaks are different, and a condition that a difference in the peak information in the plurality of peaks exceeds a predetermined range.

With the data processing device according to Clause 13, in the hierarchical clustering, a plurality of peaks included in the same analysis data, a plurality of peaks having different spectra, or a plurality of peaks having a difference in peak information exceeding a predetermined range are not grouped in the same cluster as the same component, and the data analysis can be performed with high accuracy using the hierarchical clustering.

(Clause 14) A data processing method according to another aspect includes, as processing executed by a computer (computing unit), acquiring detection data indicating signal intensity corresponding to a component in a sample detected by a detection device; and processing the detection data acquired by the acquiring. The processing the detection data includes generating a plurality of analysis data including a peak of the signal intensity based on the detection data, and generating a plurality of clusters by grouping the peak included in each of the plurality of analysis data using hierarchical clustering based on peak information corresponding to the peak. The generating the plurality of clusters includes prohibiting grouping a plurality of peaks satisfying a specific condition based on the peak information, into a same cluster in the hierarchical clustering.

With the data processing method according to Clause 14, since the computer can generate a plurality of clusters by grouping the peak included in each of the plurality of analysis data using hierarchical clustering based on the peak information corresponding to the peak, the analyst does not need to generate the plurality of clusters by estimating the peaks common among the plurality of analysis data by himself/herself, and can quickly perform the data analysis. Furthermore, in the hierarchical clustering, since the computer prohibits that the plurality of peaks satisfying the specific condition based on the peak information are grouped into the same cluster, the plurality of peaks satisfying the specific condition based on the peak information are not grouped into the same cluster as the same component, and the data analysis can be performed with high accuracy using the hierarchical clustering.

(Clause 15) A data processing program according to still another aspect causes a computer (computing unit) to execute acquiring detection data indicating signal intensity corresponding to a component in a sample detected by a detection device, and processing the detection data acquired by the acquiring. The processing the detection data includes generating a plurality of analysis data including a peak of the signal intensity based on the detection data, and generating a plurality of clusters by grouping the peak included in each of the plurality of analysis data using hierarchical clustering based on peak information corresponding to the peak. The generating the plurality of clusters includes prohibiting grouping a plurality of peaks satisfying a specific condition based on the peak information, into a same cluster in the hierarchical clustering.

With the data processing program according to Clause 15, since the computer can generate a plurality of clusters by grouping the peak included in each of the plurality of analysis data using hierarchical clustering based on the peak information corresponding to the peak, the analyst does not need to generate the plurality of clusters by estimating the peaks common among the plurality of analysis data by himself/herself, and can quickly perform the data analysis. Furthermore, in the hierarchical clustering, since the computer prohibits that the plurality of peaks satisfying the specific condition based on the peak information are grouped into the same cluster, the plurality of peaks satisfying the specific condition based on the peak information are not grouped into the same cluster as the same component, and the data analysis can be performed with high accuracy using the hierarchical clustering.

(Clause 16) A data processing system according to still another aspect includes a detection device; and a data processing device that processes data. The data processing device includes a data acquisition unit that acquires detection data indicating signal intensity corresponding to a component in a sample detected by the detection device, and a computing unit that processes the detection data acquired by the data acquisition unit. The computing unit is configured to: generate a plurality of analysis data including a peak of the signal intensity based on the detection data; generate a plurality of clusters by grouping the peak included in each of the plurality of analysis data using hierarchical clustering based on peak information corresponding to the peak; and prohibit grouping a plurality of peaks satisfying a specific condition based on the peak information, into a same cluster in the hierarchical clustering.

With the data processing system according to Clause 16, since a plurality of clusters are generated by grouping the peak included in each of the plurality of analysis data using hierarchical clustering based on the peak information corresponding to the peak, the analyst does not need to generate the plurality of clusters by estimating the peaks common among the plurality of analysis data by himself/herself, and can quickly perform the data analysis. Furthermore, in the hierarchical clustering, since data processing device 100 prohibits that the plurality of peaks satisfying the specific condition based on the peak information are grouped into the same cluster, the plurality of peaks satisfying the specific condition based on the peak information are not grouped into the same cluster as the same component, and the data analysis can be performed with high accuracy using the hierarchical clustering.

Although the embodiments of the present invention have been described, it should be considered that the embodiments disclosed herein are illustrative in all respects and not restrictive. The scope of the present invention is defined by the claims, and is intended to include meanings equivalent to the claims and all modifications within the scope.

What is claimed is:

1. A data processing device that processes data, the data processing device comprising:
a data acquisition unit that acquires detection data indicating signal intensity corresponding to a component in a sample detected by a detection device; and
a computing unit that processes the detection data acquired by the data acquisition unit,
wherein the computing unit is configured to:
generate a plurality of analysis data including a peak of the signal intensity based on the detection data;
generate a plurality of clusters by grouping the peak included in each of the plurality of analysis data using hierarchical clustering based on peak information corresponding to the peak; and
prohibit grouping a plurality of peaks satisfying a specific condition based on the peak information, into a same cluster in the hierarchical clustering.

2. The data processing device according to claim 1, wherein
the detection device is a chromatograph, and
each of the plurality of analysis data is a chromatogram illustrating a peak of the signal intensity for a retention time.

3. The data processing device according to claim 1, wherein the computing unit is configured to generate a table based on the peak information corresponding to a peak included in each of the plurality of clusters.

4. The data processing device according to claim 3, wherein the computing unit is configured to:
calculate a representative value of each of the plurality of clusters; and
generate the table based on the representative value of each of the plurality of clusters.

5. The data processing device according to claim 3, wherein the computing unit is configured to prohibit generating the table using one cluster according to the number of peaks included in the one cluster among the plurality of clusters.

6. The data processing device according to claim 3, wherein the computing unit is configured to generate the table using a peak extracted based on a difference between a peak included in one cluster and another peak included in the one cluster and a difference between a peak included in the one cluster and a peak included in another cluster.

7. The data processing device according to claim 4, wherein the computing unit is configured to calculate the representative value using a peak extracted based on a difference between a peak included in one cluster and another peak included in the one cluster and a difference between a peak included in the one cluster and a peak included in another cluster.

8. The data processing device according to claim 1, wherein the computing unit is configured to perform weighting, the weighting being larger than weighting of other peak information, on at least one piece of the peak information and execute the hierarchical clustering based on the weighted peak information.

9. The data processing device according to claim 1, wherein the computing unit is configured to exclude, among peaks included in one cluster, a peak close to a peak included in another cluster from the one cluster.

10. The data processing device according to claim 2, wherein the peak information includes at least one of the retention time, a number, a width, an area, an area ratio, a height, and a height ratio at a peak.

11. The data processing device according to claim 2, wherein the peak information includes at least one of the retention time, a number, a width, an area, an area ratio, a height, and a height ratio at a peak before or after a peak as a target of the hierarchical clustering.

12. The data processing device according to claim 1, wherein the hierarchical clustering is clustering according to at least one of a shortest distance method, a longest distance method, and a centroid method.

13. The data processing device according to claim 1, wherein the specific condition includes at least one of a condition that the plurality of peaks are included in same analysis data, a condition that spectra of the plurality of peaks are different, and a condition that a difference in the peak information in the plurality of peaks exceeds a predetermined range.

14. A data processing method for a computer to process data, the data processing method comprising:
as processing executed by the computer,
acquiring detection data indicating signal intensity corresponding to a component in a sample detected by a detection device; and
processing the detection data acquired by the acquiring,
wherein
the processing the detection data includes
generating a plurality of analysis data including a peak of the signal intensity based on the detection data, and
generating a plurality of clusters by grouping the peak included in each of the plurality of analysis data using hierarchical clustering based on peak information corresponding to the peak, and
the generating the plurality of clusters includes prohibiting grouping a plurality of peaks satisfying a specific condition based on the peak information, into a same cluster in the hierarchical clustering.

15. A data processing system that processes data, the data processing system comprising:
a detection device; and
a data processing device that processes data,
wherein
the data processing device includes
a data acquisition unit that acquires detection data indicating signal intensity corresponding to a component in a sample detected by the detection device, and
a computing unit that processes the detection data acquired by the data acquisition unit,
the computing unit is configured to:
generate a plurality of analysis data including a peak of the signal intensity based on the detection data;
generate a plurality of clusters by grouping the peak included in each of the plurality of analysis data using hierarchical clustering based on peak information corresponding to the peak; and
prohibit grouping a plurality of peaks satisfying a specific condition based on the peak information, into a same cluster in the hierarchical clustering.
